(19) United States
(12) Patent Application Publication
(10) Pub. No.: US 2023/0309547 A1
(43) Pub. Date: Oct. 5, 2023

(54) Rodent Repellent Assembly

(71) Applicant: Josh Randolph, Plainfield, IL (US)

(72) Inventor: Josh Randolph, Plainfield, IL (US)

(21) Appl. No.: 17/708,989

(22) Filed: Mar. 30, 2022

(51) Int. Cl. A01M 29/18

(52) U.S. Cl. CPC A01M 29/18

(57) ABSTRACT

A rodent repellent assembly for inhibiting rodents from chewing electrical wires of an air conditioner includes an air conditioner has an exterior wall being comprised of a ferromagnetic material. An ultrasonic emitter is provided which emits ultrasonic sound waves when the ultrasonic emitter is turned on to repel rodents. A pair of magnets is each coupled to the ultrasonic emitter. Each of the magnets magnetically engages the exterior wall of the air conditioner for mounting the ultrasonic emitter to the air conditioner. In this way the ultrasonic emitter inhibits rodents from chewing on electrical wires of the air conditioner.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to repellent devices and more particularly pertains to a new repellent device for inhibiting rodents from chewing electrical wires of an air conditioner. The device includes air conditioning unit and an ultrasonic emitter. A pair of magnets is each coupled to the ultrasonic emitter to magnetically engage an exterior wall of the air conditioner. In this way the ultrasonic emitter can repel rodents from chewing on wires of the air conditioner.

### (2) Description of Related Art Including Information Disclosed Under 37 CFR 1.97 and 1.98

The prior art relates to repellent devices including a variety of ultrasonic emitter devices that each employs novel circuitry for emitting ultrasonic sound to repel rodents.

### BRIEF SUMMARY OF THE INVENTION

An embodiment of the disclosure meets the needs presented above by generally comprising an air conditioner has an exterior wall being comprised of a ferromagnetic material. An ultrasonic emitter is provided which emits ultrasonic sound waves when the ultrasonic emitter is turned on to repel rodents. A pair of magnets is each coupled to the ultrasonic emitter. Each of the magnets magnetically engages the exterior wall of the air conditioner for mounting the ultrasonic emitter to the air conditioner. In this way the ultrasonic emitter inhibits rodents from chewing on electrical wires of the air conditioner.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an ultrasonic emitter of an embodiment of the disclosure.

FIG. 2 is a front phantom view of an embodiment of the disclosure.

FIG. 3 is a front view of an alternative embodiment of the disclosure.

FIG. 4 is a perspective view of rodent repellent assembly according to an embodiment of the disclosure.

### DETAILED DESCRIPTION OF THE INVENTION

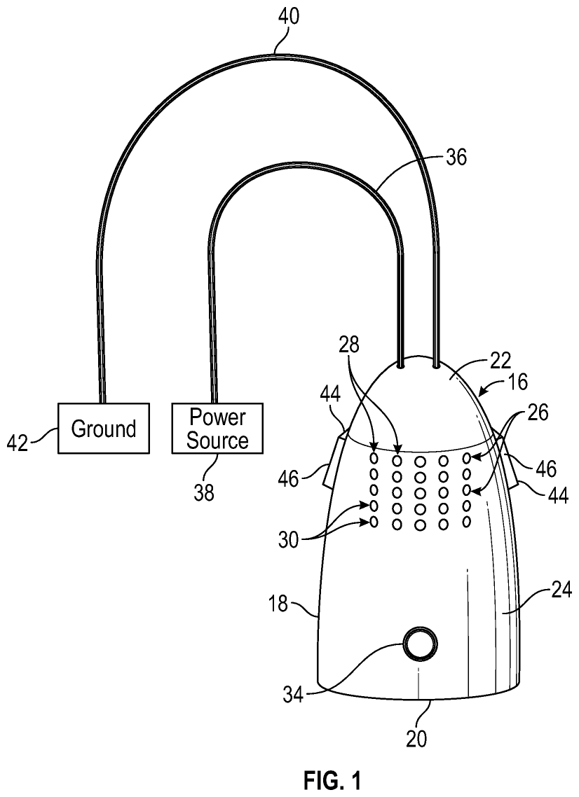

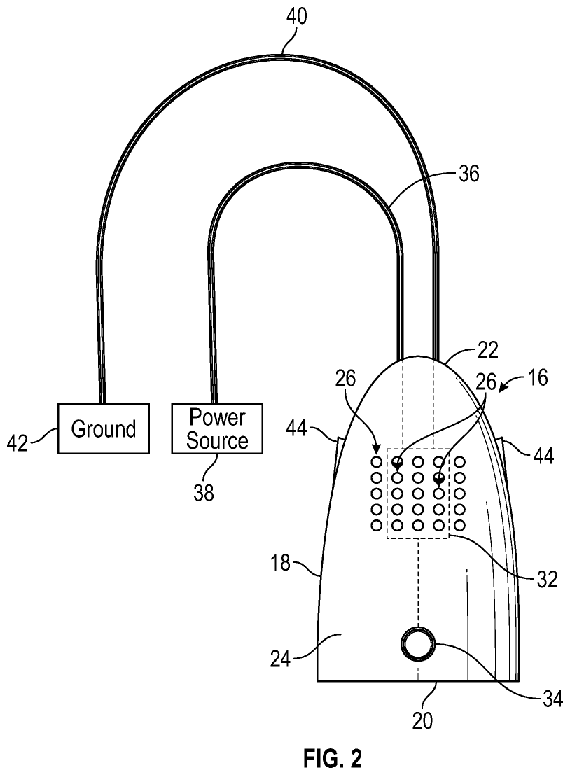

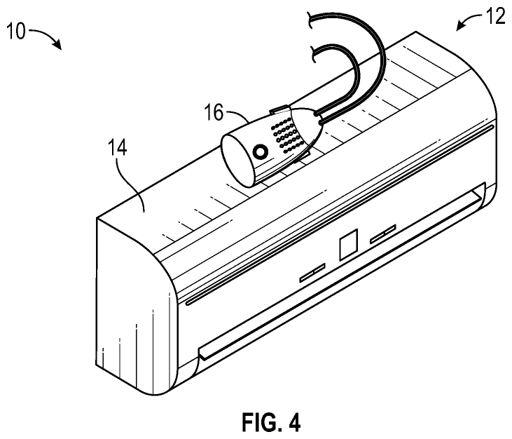

With reference now to the drawings, and in particular to FIGS. 1 through 4 thereof, a new repellent device embodying the principles and concepts of an embodiment of the disclosure and generally designated by the reference numeral 10 will be described.

As best illustrated in FIGS. 1 through 4, the rodent repellent assembly 10 generally comprises an air conditioner 12 that has an exterior wall 14 which is comprised of a ferromagnetic material. The air conditioner 12 may comprise an air conditioner of any conventional design that is commonly employed in a residence or commercial building. Furthermore, the air conditioner 12 might comprise a heat pump, a mini split unit or any type of component of a heating, air conditioning and ventilation system that is positioned either inside of a building or outside of a building. An ultrasonic emitter 16 is provided which emits ultrasonic sound waves when the ultrasonic emitter 16 is turned on to repel rodents. The ultrasonic emitter 16 comprises a housing 18 that has a first end 20, a second end 22 and an outer wall 24 extending between the first end 20 and the second end 22. The first end 20 is flattened, the second end 22 is rounded and the outer wall 24 is continuously arcuate about an axis extending between the first end 20 and the second end 22 such that the housing 18 has a cylindrical shape. The outer wall 24 tapers inwardly between the first end 20 and the second end 22 such that the housing 18 has a bullet shape.

The outer wall 24 has a plurality of holes 26 each extending into an interior of the housing 18. The plurality of holes 26 is arranged into a plurality of columns 28 and rows and the plurality of holes 26 is positioned closer to the second end 22 than the first end 20. A sound emitter 32 is positioned within the housing 18 and the sound emitter 32 is aligned with the plurality of holes 26 to emit sound outwardly through the plurality of holes 26. The sound emitter 32 has an operational frequency ranging between 20.0 kHz and 30.0 kHz thereby facilitating the sound emitter 32 to repel rodents.

A light emitter 34 is integrated into the outer wall 24 of the housing 18 to emit light outwardly from the outer wall 24. The light emitter 34 is electrically coupled to the sound emitter 32 and the light emitter 34 is turned on when the sound emitter 32 is turned on. In this way the light emitter 34 can alert an observer that the sound emitter 32 has been turned on. The light emitter 34 is positioned between the plurality of holes 26 and the first end 20 of the housing 18. Furthermore, the light emitter 34 may comprise a light emitting diode or other type of electronic light emitter.

A power cord 36 is coupled to and extends away from the second end 22 of the housing 18 and the power cord 36 is electrically coupled to the sound emitter 32. Furthermore, the power cord 36 is electrically coupled to a power source 38. The power source 38 may comprise a female electrical outlet, wiring of an electrical system of the building in which the air conditioner 12 is positioned or any other source of electrical current. A ground cord 40 is coupled to and extends away from the second end 22 of the housing 18 and the ground cord 40 is electrically coupled to the sound emitter 32. Additionally, the ground cord 40 is electrically coupled to a ground 42. The ground 42 may comprise a ground of the electrical system of the building in which the air conditioner 12 is positioned or any other source of Earth ground.

A pair of magnets 44 is provided and each of the magnets 44 is coupled to the ultrasonic emitter 16. Each of the magnets 44 magnetically engages the exterior wall 14 of the air conditioner 12 for mounting the ultrasonic emitter 16 to the air conditioner 12. In this way the ultrasonic emitter 16 can inhibit rodents from chewing on electrical wires of the air conditioner 12. Each of the magnets 44 is positioned on the outer wall 24 of the housing 18 and each of the magnets 44 is positioned on an opposite side of the housing 18 with respect to the plurality of holes 26 and the light emitter 34. Each of the magnets 44 is positioned closer to the second end 22 of the housing 18 than the first end 20 of the housing 18. The housing 18 can be placed either on an outer surface of the exterior wall 14 of the air conditioner 12 or on an inside surface of the exterior wall 14 of the air conditioner 12. In this way the housing 18 and the ultrasonic emitter 16 can be protected from precipitation, for example, if the air conditioner 12 is placed outside of the building.

The magnets 44 are spaced apart from each other along an axis that is oriented perpendicular to the axis extending between the first end 20 and the second end 22 of the housing 18. Each of the magnets 44 has a distal surface 46 with respect to the outer wall 24 of the housing 18. Additionally, the distal surface 46 of a respective one of the magnets 44 magnetically engages the exterior wall 14 of the air conditioner 12 thereby facilitating the plurality of holes 26 in the outer wall 24 of the housing 18 to be directed in a preferred direction. Each of the magnets 44 may comprise an Earth magnet or other type non-electronic magnet.

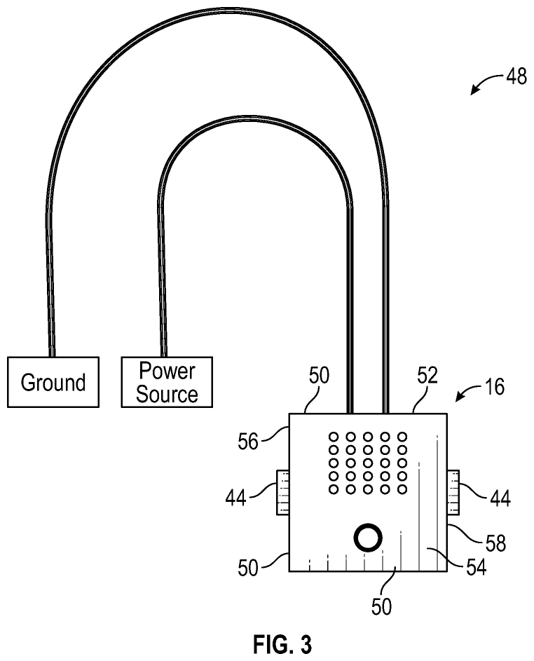

In an alternative embodiment 48 as is most clearly shown in FIG. 3, the housing 18 has a plurality of intersecting faces 50 and the plurality of the faces 50 is perpendicularly oriented with each other such that the housing 18 has a cubic shape. The plurality of faces 50 includes a top face 52, a front face 54, a first lateral face 56 and a second lateral face 58. Each of the plurality of holes 18 and the light emitter 34 is positioned on the front face 54. Each of the magnets 44 is positioned on a respective one of the first lateral face 56 and the second lateral face 58. Additionally, each of the power cord 36 and the ground cord 40 is positioned on the top face 52.

In use, each of the power cord 36 and the ground cord 40 are electrically coupled to the respective power source 38 and ground 42 in accordance with the National Electrical Code. A respective one of the magnets 44 is engaged to the exterior wall 14 of the air conditioner 12 thereby facilitating the plurality of holes 26 to be directed in a preferred direction. In this way the sound emitter 32 can emit the ultrasonic sound in a manner that can most effectively repel rodents. Thus, wiring and other components of the air conditioner 12 are protected from being chewed on by rodents, such as mice and other similar rodents that are known to commonly chew on insulation of electrical conductors.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. (canceled)

2. A rodent repellent assembly for repelling rodents from an air conditioning unit, said assembly comprising:
an air conditioner having an exterior wall being comprised of a ferromagnetic material:
an ultrasonic emitter emitting ultrasonic sound waves when said ultrasonic emitter is turned on wherein said ultrasonic emitter is configured to repel rodents;
a pair of magnets, each of said magnets being coupled to said ultrasonic emitter, each of said magnets magnetically engaging said exterior wall of said air conditioner for mounting said ultrasonic emitter to said air conditioner wherein said ultrasonic emitter is configured to inhibit rodents from chewing on electrical wires of said air conditioner; and
wherein said ultrasonic emitter comprises:
a housing having a first end, a second end and an outer wall extending between said first end and said second end, first end being flattened, said second end being rounded, said outer wall being continuously arcuate about an axis extending between said first end and said second end such that said housing has a cylindrical shape, said outer wall tapering inwardly between said first end and said second end such that said housing has a bullet shape; and
said outer wall has a plurality of holes each extending into an interior of said housing, said plurality of holes being arranged into a plurality of columns and rows, said plurality of holes being positioned closer to said second end than said first end.

3. The assembly according to claim 2, wherein said ultrasonic emitter includes a sound emitter being positioned within said housing, said sound emitter being aligned with said plurality of holes wherein said sound emitter is configured to emit sound outwardly through said plurality of holes, said sound emitter having an operational frequency ranging between 20.0 kHz and 30.0 kHz wherein said sound emitter is configured to repel rodents.

4. The assembly according to claim 3, wherein said ultrasonic emitter includes a light emitter being integrated into said outer wall of said housing wherein said light emitter is configured to emit light outwardly from said outer wall, said light emitter being electrically coupled to said sound emitter, said light emitter being turned on when said sound emitter is turned on wherein said light emitter is configured to alert an observer that said sound emitter has been turned on, said light emitter being positioned between said plurality of holes and said first end of said housing.

5. The assembly according to claim 3, wherein said ultrasonic emitter includes:
a power cord being coupled to and extending away from said second end of said housing, said power cord being electrically coupled to said sound emitter, said power cord being electrically coupled to a power source; and
a ground cord being coupled to and extending away from said second end of said housing, said ground cord being electrically coupled to said sound emitter, said ground cord being electrically coupled to a ground.

6. The assembly according to claim 4, wherein each of said magnets is positioned on said outer wall of said housing, each of said magnets being positioned on an opposite side of said housing with respect to said plurality of holes and said light emitter, each of said magnets being positioned closer to said second end of said housing than said first end of said housing.

7. The assembly according to claim 2, wherein said magnets are spaced apart from each other along an axis being oriented perpendicular to said axis extending between said first end and said second end of said housing, each of said magnets having a distal surface with respect to said outer wall of said housing, said distal surface of a respective one of said magnets magnetically engaging said exterior wall of said air conditioner thereby facilitating said plurality of holes in said outer wall of said housing to be directed in a preferred direction.

8. A rodent repellent assembly for repelling rodents from an air conditioning unit, said assembly comprising:
an air conditioner having an exterior wall being comprised of a ferromagnetic material;
an ultrasonic emitter emitting ultrasonic sound waves when said ultrasonic emitter is turned on wherein said ultrasonic emitter is configured to repel rodents, said ultrasonic emitter comprising:
a housing having a first end, a second end and an outer wall extending between said first end and said second end, first end being flattened, said second end being rounded, said outer wall being continuously arcuate about an axis extending between said first end and said second end such that said housing has a cylindrical shape, said outer wall tapering inwardly between said first end and said second end such that said housing has a bullet shape, said outer wall having a plurality of holes each extending into an interior of said housing, said plurality of holes being arranged into a plurality of columns and rows, said plurality of holes being positioned closer to said second end than said first end;
a sound emitter being positioned within said housing, said sound emitter being aligned with said plurality of holes wherein said sound emitter is configured to emit sound outwardly through said plurality of holes, said sound emitter having an operational frequency ranging between 20.0 kHz and 30.0 kHz wherein said sound emitter is configured to repel rodents;
a light emitter being integrated into said outer wall of said housing wherein said light emitter is configured to emit light outwardly from said outer wall, said light emitter being electrically coupled to said sound emitter, said light emitter being turned on when said sound emitter is turned on wherein said light emitter is configured to alert an observer that said sound emitter has been turned on, said light emitter being positioned between said plurality of holes and said first end of said housing;
a power cord being coupled to and extending away from said second end of said housing, said power cord being electrically coupled to said sound emitter, said power cord being electrically coupled to a power source; and
a ground cord being coupled to and extending away from said second end of said housing, said ground cord being electrically coupled to said sound emitter, said ground cord being electrically coupled to a ground; and
a pair of magnets, each of said magnets being coupled to said ultrasonic emitter, each of said magnets magnetically engaging said exterior wall of said air conditioner for mounting said ultrasonic emitter to said air conditioner wherein said ultrasonic emitter is configured to inhibit rodents from chewing on electrical wires of said air conditioner, each of said magnets being positioned on said outer wall of said housing, each of said magnets being positioned on an opposite side of said housing with respect to said plurality of holes and said light emitter, each of said magnets being positioned closer to said second end of said housing than said first end of said housing, said magnets being spaced apart from each other along an axis being oriented perpendicular to said axis extending between said first end and said second end of said housing, each of said magnets having a distal surface with respect to said outer wall of said housing, said distal surface of a respective one of said magnets magnetically engaging said exterior wall of said air conditioner thereby facilitating said plurality of holes in said outer wall of said housing to be directed in a preferred direction.

9. The assembly according to claim 8, wherein said housing has a plurality of intersecting faces, said plurality of said faces being perpendicularly oriented with each other such that said housing has a cubic shape, said plurality of faces including a top face, a front face, a first lateral face and a second lateral face.

10. The assembly according to claim 9, wherein each of said plurality of holes and said light emitter is positioned on said front face.

11. The assembly according to claim 9, wherein each of said magnets is positioned on a respective one of said first lateral face and said second lateral face.

12. The assembly according to claim 9, wherein each of said power cord and said ground cord is positioned on said top face.
